(19) United States
(12) Patent Application Publication
(10) Pub. No.: US 2008/0009072 A1
(43) Pub. Date: Jan. 10, 2008

(54) ULTRASONIC MIXING OF A BIOLOGICAL SAMPLE

(75) Inventors: Robert Sakal, Bolton, MA (US); Corey DeLisle, Fitchburg, MA (US); Tim Hutchins, Attleboro Falls, MA (US); Hal Watts, Holden, MA (US)

Correspondence Address: Vista IP Law Group LLP, Suite D-2, 12930 Saratoga Avenue, Saratoga, CA, 95070, US

(73) Assignee: Cytyc Corporation, Marlborough, MA (US)

(21) Appl. No.: 11/456,180

(22) Filed: Jul. 7, 2006

(51) Int. Cl. G01N 1/00

(52) U.S. Cl. 436/174

(57) ABSTRACT

Disclosed herein is a method of preparing a slide for viewing biological material, comprising obtaining a vial containing the biological material in a solution; sonicating the solution to obtain a mixed solution; selectively removing cells from the mixed solution by aspirating a portion of the solution through a membrane such that the cells adhere to the membrane; and transferring the cells adhered to the membrane to a microscope slide. Also disclosed herein is an apparatus for performing the above method.

### FIELD OF THE INVENTION

The present invention relates to preparation of cytological specimens and, more specifically, to an automated method and apparatus that sonicates the samples prior to preparing a plurality of cytological specimens.

### BACKGROUND

Cytology is a branch of biology dealing with the study of the formation, structure, and function of cells. As applied in a laboratory setting, cytologists, cytotechnologists, and other medical professionals make medical diagnoses of a patient's condition based on visual examination of a specimen of the patient's cells. A typical cytological technique is a “pap smear” test, in which cells are scraped from a woman's cervix and analyzed in order to detect the presence of abnormal cells, a precursor to the onset of cervical cancer. Cytological techniques are also used to detect abnormal cells and disease in other parts of the human body.

Cytological techniques are widely employed because collection of cell samples for analysis is generally less invasive than traditional surgical pathological procedures such as biopsies, whereby a tissue specimen is excised from the patient using specialized biopsy needles having spring loaded translatable stylets, fixed cannulae, and the like. Cell samples may be obtained from the patient by a variety of techniques including, for example, by scraping or swabbing an area, or by using a needle to aspirate body fluids from the chest cavity, bladder, spinal canal, or other appropriate area. The cell samples are placed in solution and subsequently collected and transferred to a glass slide for viewing under magnification. Fixative and staining solutions may be applied to the cells on the glass slide for preserving the specimen for archival purposes and for facilitating examination.

It is generally desirable that the cells on the slide have a proper spatial distribution, so that individual cells can be examined. A single layer of cells is typically preferred. Accordingly, preparing a specimen from a fluid sample containing many cells typically requires that the cells first be separated from each other by mechanical dispersion, fluidic shear, or other techniques so that a thin, monolayer of cells can be collected and deposited on the slide. In this manner, the cytotechnologist can more readily discern abnormal cells. The cells are also able to be counted to ensure that an adequate number of cells have been evaluated.

Certain methods and apparatus for generating a thin monolayer of cells on a slide advantageous for visual examination are disclosed in U.S. Pat. No. 5,143,627 issued to Lapidus et al. and entitled “Method and Apparatus for Preparing Cells for Examination;” U.S. Pat. No. 5,240,606 issued to Lapidus et al. and entitled “Apparatus for Preparing Cells for Examination;” U.S. Pat. No. 5,269,918 issued to Lapidus et al. and entitled “Clinical Cartridge Apparatus;” and U.S. Pat. No. 5,282,978 issued to Polk, Jr. et al. and entitled “Specimen Processor Method and Apparatus,” all of which are assigned to the assignee of the present invention and all of the disclosures of which are incorporated herein by reference in their entirety.

According to one method disclosed in these patents, a patient's cells in a preservative fluid in a sample container are dispersed using a spinning sample collector disposed therein. A controlled vacuum is applied to the sample collector to draw the fluid through a screen filter thereof until a desired quantity and spatial distribution of cells is collected against the filter. Thereafter, the sample collector is removed from the sample container and the filter portion impressed against a glass slide to transfer the collected cells to the slide in substantially the same spatial distribution as collected. Another method, disclosed in U.S. Patent Application Publication No. 2003-0207456 A1, by Ostgaard et al., the content of which is incorporated by reference herein in its entirety, including any drawings, is directed to a more automated preparation of glass slides.

Sonication is a very effective method for the mixing and homogenizing of liquids by means of ultrasonic cavitation. Some of the instruments currently used in the market include the VialTweeter (Hielscher Ultrasonics GmbH, Germany)

In some of the current automated pap smear sample preparation techniques the sample is mechanically agitated to break up mucous, blood, or cell clusters, for example by spinning the filter in the vial in ThinPrep® TP2000 (Cytyc Corp.) or spinning the vial itself ThinPrep® TP3000 (Cytyc Corp.). The mechanical agitation leads to splashes and spreading of the fluid and cellular matter on the inside of the instrument. This leads to excess cleaning required by the user and potential contamination of the interior of the device with cellular matter. Furthermore, once the mechanical mixing stops, the cell contents begin to settle within the vial and reform aggregates, which may potentially lead to a less accurate representation of the vial contents on the slide.

Therefore, there is a need in the art for an alternative method of mixing that can mix the sample without removing the lid on the vial, and that can continue to mix the contents of the vial while the cell fractions are being obtained.

### SUMMARY OF THE INVENTION

Disclosed herein is a method of preparing a slide for viewing biological material, comprising obtaining a vial containing the biological material in a solution; sonicating the solution to obtain a mixed solution; selectively removing cells from the mixed solution by aspirating a portion of the solution through a membrane such that the cells adhere to the membrane; and transferring the cells adhered to the membrane to a microscope slide.

Also disclosed herein is an apparatus for preparing a slide for viewing biological material, comprising a specimen preparing apparatus; a first loading station for receiving a plurality of samples; a sample transfer assembly for removing a first sample from the first loading station and transferring the first sample to the specimen preparing apparatus for preparing a first specimen from the first sample and thereafter returning the the sample to the first loading station; a sonicator for sonicating the first sample in the specimen preparing apparatus; a specimen transfer assembly for transferring the first specimen to an unloading area; and a processor for automatically controlling the the specimen preparing apparatus, the sample transfer assembly, the sonicator, and the specimen transfer assembly, such that remaining ones of the plurality of samples are processed to prepare subsequent specimens until all of the plurality of samples have been processed.

### DETAILED DESCRIPTION OF THE ILLUSTRATIVE EMBODIMENTS

Embodiments of the present invention are described below. It is, however, expressly noted that the present invention is not limited to these embodiments, but rather the intention is that modifications that are apparent to the person skilled in the art and equivalents thereof are also included.

Aspects of the current invention provide for the use of ultrasound energy to mix the contents of a vial within an instrument. The use of ultrasound energy, or sonication, is more superior mixing technique than mechanical mixing because ultrasound can be used on a closed vial, which virtually eliminates splashes and spilling of the contents of the vial within the instrument. Furthermore, when the vial cap is removed, sonication creates much smaller ripples within the vial and therefore minimizes unwanted spills. When used with ThinPrep® TP2000 and TP3000 instruments, an added ultrasound device can continue mixing the contents of the vial while cells are being removed from the sample, thereby assure a homogenous sample from which cells are obtained. This leads to a more accurate representation of the contents of the sample on the slide.

Thus, in a first aspect, disclosed herein is a method of preparing a slide for viewing biological material, comprising obtaining a vial containing the biological material in a solution; sonicating the solution to obtain a mixed solution; selectively removing cells from the mixed solution by aspirating a portion of the solution through a membrane such that the cells adhere to the membrane; and transferring the cells adhered to the membrane to a microscope slide.

In some embodiments, the biological material is obtained from the cervix. In certain embodiments, the biological material comprises cervical cells, blood, and mucous. In other embodiments, the biological sample is blood sample. In yet other embodiments, the biological sample is urine.

In some embodiments, the biological sample is in PreservCyt® (Cytyc Corp.). In other embodiments, the biological sample is in water. In yet other embodiments, the biological sample is in a buffer solution, such as HEPES (N-(2-hydroxyethyl)piperazine-N′-(2-ethanesulfonic acid)), MES (2-(N-morpholino)ethane-sulfonic acid), MOPS (3-(N-morpholino)propanesulfonic acid), TRIS, TBS (Tris buffered saline), BIS-TRIS Propane (1,3-Bis[tris(hydroxymethyl)methylamino]propane), PBS (phosphate buffered saline), and the like.

In some embodiments, the sonication is performed by using ultrasound energy.

In some embodiments, the sonicating step produces a homogenized solution. In certain embodiments, the sonicating step breaks up mucous, blood, or cell clusters.

With some automated slide preparation devices, such as ThinPrep® TP2000 and TP3000 instruments, the instruments obtains a membrane and aspirates some of the solution containing the biological sample through the membrane. Some of the cells in the sample solution adhere to the membrane. The instrument, then presses the membrane against a glass slide, thereby transferring the cells to the glass slide.

In some embodiments, the above method further comprises sonicating the solution prior to aspirating the portion of the solution through the membrane. In these embodiments, the solution is sonicated for long enough time to ensure that all of the cell clusters have been broken up and that the solution is sufficiently homogenized.

In other embodiments, the above method further comprises sonicating the solution while aspirating the portion of the solution through the membrane. In these embodiments, continued sonication while aspirating ensures that very few, if any, new cell clusters are re-formed prior to obtaining the cells on the membrane.

In another aspect, disclosed herein is an apparatus for preparing a slide for viewing biological material, comprising a specimen preparing apparatus; a first loading station for receiving a plurality of samples; a sample transfer assembly for removing a first sample from the first loading station and transferring the first sample to the specimen preparing apparatus for preparing a first specimen from the first sample and thereafter returning the the sample to the first loading station; a sonicator for sonicating the first sample in the specimen preparing apparatus; a specimen transfer assembly for transferring the first specimen to an unloading area; and a processor for automatically controlling the the specimen preparing apparatus, the sample transfer assembly, the sonicator, and the specimen transfer assembly, such that remaining ones of the plurality of samples are processed to prepare subsequent specimens until all of the plurality of samples have been processed.

In some embodiments, each sample comprises particles in a liquid suspension. In further embodiments, the particles comprise cells

In some embodiments, the above apparatus further comprises a coating station for coating each prepared specimen with a fixative solution.

Some embodiments of the above apparatus further comprise a second loading station for receiving a plurality of membranes; and a membrane transfer assembly under control of the processor for removing a first membrane from the first loading station and transferring the first membrane to the specimen preparing apparatus for preparing a first specimen from the first sample and thereafter discarding the first membrane, where the processor automatically controls the membrane transfer assembly, such that a next one of the plurality of membranes is transferred to the specimen preparing apparatus to prepare a next specimen from a next sample until all of the plurality of samples have been processed.

In some embodiments, the sonicator sonicates the first sample in the first loading station. In other embodiments, the sonicator sonicates the first sample in the specimen preparing apparatus. In yet other embodiments, the sonicator sonicates the first sample prior to the first membrane being transferred to the specimen preparing apparatus. In yet other embodiments, the sonicator sonicates the first sample while the first membrane is being transferred to the specimen preparing apparatus. In certain embodiments, the sonicator sonicates the first sample in the first loading station and continues to sonicate the sample until the membrane has obtained a sufficient number of cells.

The invention may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

1. A method of preparing a slide for viewing biological material wherein said biological material is present in a solution in a vial, comprising:
sonicating said solution to obtain a mixed solution;
selectively removing cells from said mixed solution by aspirating a portion of said solution through a membrane such that said cells adhere to said membrane; and
transferring said cells adhered to said membrane to a microscope slide.

2. The method of claim 1, wherein said sonication is performed by using ultrasound energy.

3. The method of claim 1, wherein said sonicating step produces a homogenized solution.

4. The method of claim 1, wherein said sonicating step breaks up mucous, blood, or cell clusters.

5. The method of claim 1, further comprising sonicating said solution prior to aspirating said portion of said solution through said membrane.

6. The method of claim 1, further comprising sonicating said solution while aspirating said portion of said solution through said membrane.

7. An apparatus for preparing a slide for viewing biological material, comprising:
a specimen preparing apparatus;
a first loading station for receiving a plurality of samples;
a sample transfer assembly for removing a first sample from said first loading station and transferring said first sample to the specimen preparing apparatus for preparing a first specimen from said first sample and thereafter returning the said sample to said first loading station;
a sonicator for sonicating said first sample in said specimen preparing apparatus;
a specimen transfer assembly for transferring said first specimen to an unloading area; and
a processor for automatically controlling said the specimen preparing apparatus, said sample transfer assembly, said sonicator, and said specimen transfer assembly, such that remaining ones of said plurality of samples are processed to prepare subsequent specimens until all of said plurality of samples have been processed.

8. The apparatus of claim 7, wherein each sample comprises particles in a liquid suspension.

9. The apparatus of claim 8, wherein said particles comprise cells

10. The apparatus of claim 7, further comprising a coating station for coating each prepared specimen with a fixative solution.

11. The apparatus of claim 7, further comprising:
a second loading station for receiving a plurality of membranes; and
a membrane transfer assembly under control of said processor for removing a first membrane from said first loading station and transferring said first membrane to the specimen preparing apparatus for preparing a first specimen from said first sample and thereafter discarding said first membrane,
wherein said processor automatically controls said membrane transfer assembly, such that a next one of said plurality of membranes is transferred to said specimen preparing apparatus to prepare a next specimen from a next sample until all of said plurality of samples have been processed.

12. The apparatus of claim 11, wherein said sonicator sonicates said first sample in said first loading station.

13. The apparatus of claim 11, wherein said sonicator sonicates said first sample in said specimen preparing apparatus.

14. The apparatus of claim 11, wherein said sonicator sonicates said first sample prior to said first membrane being transferred to said specimen preparing apparatus.

15. The apparatus of claim 11, wherein said sonicator sonicates said first sample while said first membrane is being transferred to said specimen preparing apparatus.
